(19) United States
(12) Patent Application Publication
(10) Pub. No.: US 2008/0099101 A1
(43) Pub. Date: May 1, 2008

(54) Holding fixture for all types of drilling concerning woodworking

(76) Inventor: Vance Chiang, Taichung City (TW)

Correspondence Address: Vance Chiang, 5F.-2, No.212, Sec. 1, Wunsin Rd., Taichung City, omitted

(21) Appl. No.: 11/544,847

(22) Filed: Oct. 10, 2006

(51) Int. Cl. B27M 3/00; B27L 9/00; B27C 9/00; B27L 3/00; B27L 5/00

(52) U.S. Cl. 144/2.1

(57) ABSTRACT

The invention proposes a holding fixture for use in all types of drilling concerning woodworking, comprised of at least one flat worktable having a set of dovetailing portions at the rear end for two flat worktables to dock together horizontally; a longitude-transverse adjustment module vertically arranged on the flat worktable, which secures the guide members for guiding the adjustments of height or latitude during drilling; an angle adjustment module being aligned at the front edge of said flat worktable, which guides the drilling operation on workpieces attached thereof; a height adjustment module vertically arranged at the front edge of flat worktable; a clamp member being secured on the flat worktable for securing workpieces to be worked on; as a result, the holding fixture is suitable for use in guiding the drilling operation on workpiece of all shapes and sizes.

### FIELD OF THE INVENTION

The invention relates to the operation of drilling in DIY woodworking. More particularly, it is related to a holding fixture that is suitable for use in all types of drilling concerning woodworking.

### DESCRIPTION OF PRIOR ART

In woodworking, angularly drilled holes are important for joining workpieces, but to prevent the holes from being excessively drilled, leading to damaged workpieces, the drill bit also needs to be placed at an angle. The angular holes are fitted with screws for securing more components. In the prior arts related to the drilling of angular holes, for example, in U.S. Pat. No. 4,955,766, it is necessary to draw precise guidelines and then make puncture holes prior to carrying out angular drilling with the use of relevant modules. However, the modules are designed fixed during drilling, and as a result, subsequent operations are time-consuming, and the drill bit is easily damaged.

Moreover, as of U.S. Pat. No. 5,791,835 “HOLDING FIXTURE USED IN WOODWORKING FOR PREPARING POCKET JOINTS” (also designed by the inventor of this disclosure), a guide rod is fixed, and another guide rod is horizontally movable. Though such design can solve the disadvantages found in the prior art described above, the drilling operation is still not entirely convenient because only one of the guide rods can be adjusted horizontally, the height of the workpiece cannot be adjusted, and the guide sleeve is fixed in the through-hole of the guide rods, which impedes the cleaning of wooden chips from the guide rods.

Furthermore, the holding fixture disclosed in U.S. Pat. Nos. 5,791,835 and 4,955,766 can only hold workpieces with flat rectangular surfaces, workpieces in the shape of sticks, rods, and especially cylinders are difficult to hold, which is a major obstacle in the drilling process.

### SUMMARY OF THE INVENTION

The main objective of the invention is to provide a holding fixture suitable for use in all types of drilling concerning woodworking that can be readily adjusted according to the various shapes and sizes of the workpieces to best guide the drilling operations.

Therefore, the invention proposes a holding fixture that is suitable for use in all types of drilling concerning woodworking, comprising:

at least one flat worktable having a set of horizontal front alignment openings on the left and the right edges, and a horizontal front recess indented at center, the rear end of said flat worktable also has a set of dovetailing portion for two said flat worktables to dovetail into each other horizontally;

a longitude-transverse adjustment module comprising two parallel support members vertically arranged on the left and right front edges of said flat worktable, the two parallel support members have a corresponding longitudinal sliding trough on the opposing surfaces, respectively, an adjustment piece being embedded between and movable along said two longitudinal sliding troughs, a transverse sliding trough being through said adjustment piece, a guide member with a plurality of guide openings being horizontally movable in said transverse sliding trough for guiding drilling operations after said adjustment piece have been adjusted;

an angle adjustment module comprising a base member fittingly matches said recess on the front edge of flat worktable, V-shaped supporting portions being disposed at the front and rear edges of said base member for supporting and aligning a workpiece, pivotal bases being correspondingly disposed at the left and the right edges of said base member for adjusting and aligning angles, rods of predetermined length being vertically fitted at the top of said pivotal bases, a sliding slot being fitted through two said rods, a fastener being fitted through the central axis of said sliding slot for securing a drill bit, said fastener has a driveshaft at the top for linking to external driving force;

a height adjustment module comprising two parallel support members vertically fitted into the recess at the front edge of said flat worktable, the two parallel support members have corresponding longitudinal sliding troughs on the opposing surface, respectively, a height adjustment piece being embedded between and movable along said two longitudinal sliding troughs, a guide member with guide openings being disposed through said height adjustment piece for guiding drilling operations after said height adjustment piece have been adjusted;

a clamp member attached on the flat worktable, the front end of said clamp member includes a fastener for securing a workpiece;

the resulting device is for use in guiding the drilling operation on workpieces of all shapes and sizes.

The advantages of the above-mentioned and other objectives of the invention can be further understood from reading the detailed description and figures of the preferred embodiments listed in the following paragraphs. Although some of the components or arrangements of components in the invention may vary, the selected embodiments are explained in details and their structure fully displayed in the attached figures of this disclosure.

### BRIEF DESCRIPTION OF DRAWINGS

FIG. 1 is a three-dimensional decomposition view showing one of the preferred embodiments of the invention.

FIG. 2 is a three-dimensional integrated view showing the first operation mode of the invention.

FIG. 3 is a schematic view showing the longitude-transverse adjustment in FIG. 2 of the invention. FIG. 4 is a schematic view showing the drilling operation in FIG. 2 of the invention.

FIG. 5 is a three-dimensional integrated view showing the second operation mode of the invention.

FIG. 6 is a schematic view showing the height adjustment in FIG. 5 of the invention.

FIG. 7 is a schematic view showing the pivotal angle adjustment in FIG. 5 of the invention.

FIG. 8 is a three-dimensional integrated view showing the third operation mode of the invention.

### DETAILED DESCRIPTION OF PREFERRED EMBODIMENT

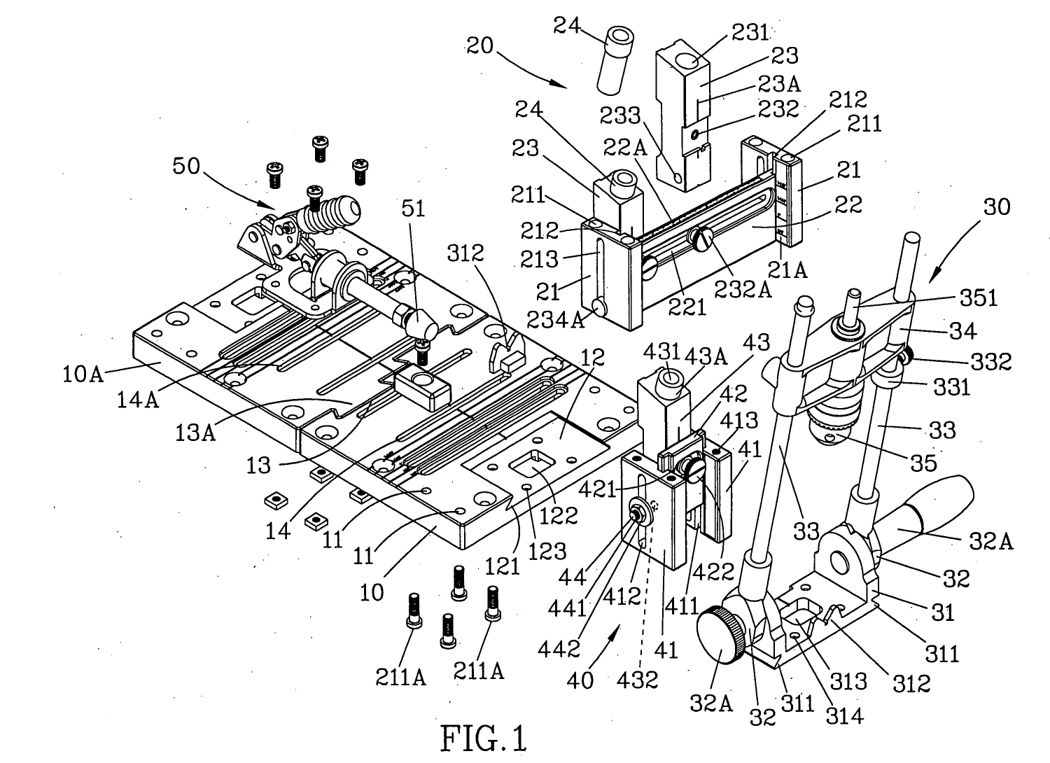

The invention proposes a holding fixture for all types of drilling that concerns woodworking, as shown in FIG. 1, it comprises two flat worktables 10, a longitude-transverse adjustment module 20, an angle adjustment module 30, a height adjustment module 40, and a clamp member 50; wherein:

said flat worktables 10 and 10 A having a set of horizontal front alignment openings 11 on the left and the right edges, and a horizontal front recess 12 indented at center, said recess 12 has angularly indented symmetrical dovetail-shaped troughs 121 on the left and the right lateral sides, respectively, a rectangular indentation 122 being indented downwardly at center and four alignment openings 123 being disposed on its four corners; the rear end of said flat worktable also has a set of dovetailing portions 13 and 13A, said dovetailing portions 13 and 13A being symmetrical in the protruding and indented portions, as indicated in FIG. 1, two said flat worktables 10 and 10A dovetail into each other horizontally, and a plurality of parallel alignment grooves 14 being disposed on the edges near dovetailing portions 13 and 13A for locking and securing other components, like clamp member 50;

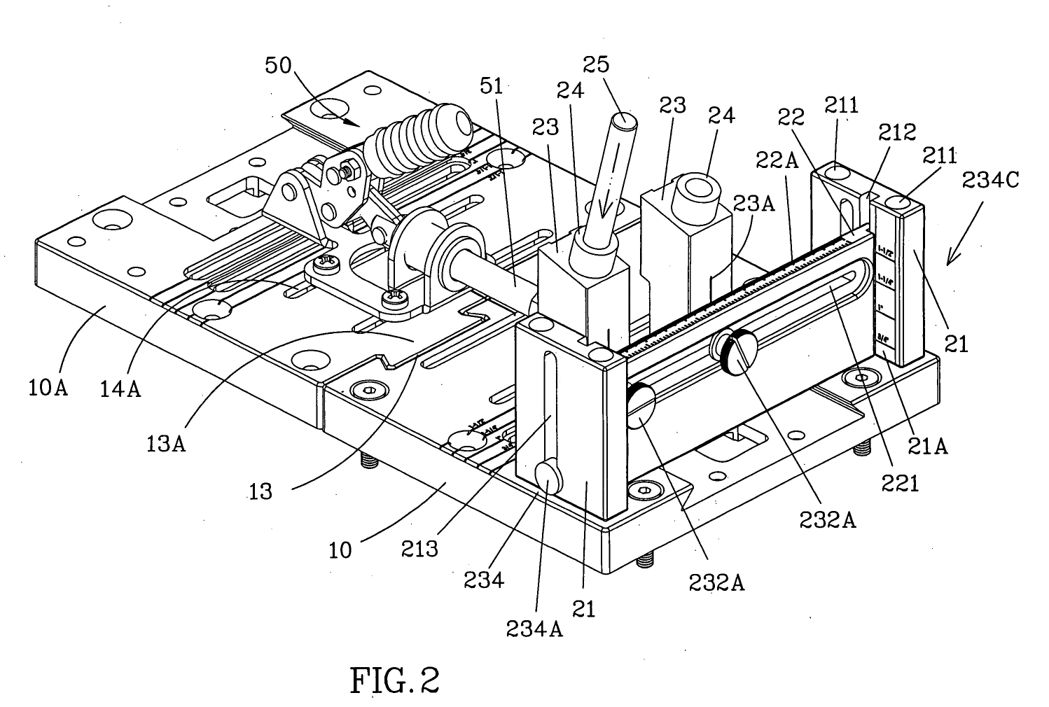

said longitude-transverse adjustment module 20, as shown in FIGS. 1 to 3, comprising two parallel support members 21 vertically arranged on the left and right front edges of said flat worktable 10, said parallel support members 21 include two longitudinally formed pivotal openings 211 for securing said parallel support members at alignment openings 11 on said flat worktable 10 with the use of fastening screws 211A, said parallel support members 21 have corresponding longitudinal sliding troughs 212 on the opposing surfaces, respectively, an adjustment piece 22 being embedded between and movable along said two longitudinal sliding troughs 212; a transverse sliding trough 221 being through said adjustment piece 22, a guide member 23 with a plurality of guide openings 231 being horizontally movable in said transverse sliding trough 221; a screw opening 232 is disposed on the side of said guide member 23 opposing said adjustment piece 22, and being secured into transverse sliding trough 221 with the use of a fastening screw 232A, said guide opening 231 includes, a guide sleeve 24 on its active axis for guiding a drill bit 25; the height or latitude of said adjustment piece being adjustable with the use of said adjustment piece for guiding the drilling operation; the surface faces away from said longitudinal sliding trough 212 in the two parallel support members 21 being formed with symmetrically indented through troughs 213, and the lateral side of said guide member 23 being horizontally formed with a through opening 233, with a horizontal rod 234 being screwed into said through trough at both ends, and said horizontal rod 234 being secured into said through trough 213 with the use of a bolt 234B on the rear end thereof and a nut 234C on the front end 234A; furthermore, as shown in FIG. 2, the top edge of said adjustment piece 22 has a marked ruler 22A, and said guide member 23 has a marked notch 23A along its middle longitudinal line, the combination of said marked notch 23A and said marked ruler 22A on the adjustment piece 22 accurately measure the degree of horizontal movement of said guide member 23; the lateral edge located proximally to said longitudinal sliding trough 212 of said parallel support member 21 also has a marked ruler 21A for accurately measuring the degree of vertical movement of said guide member;

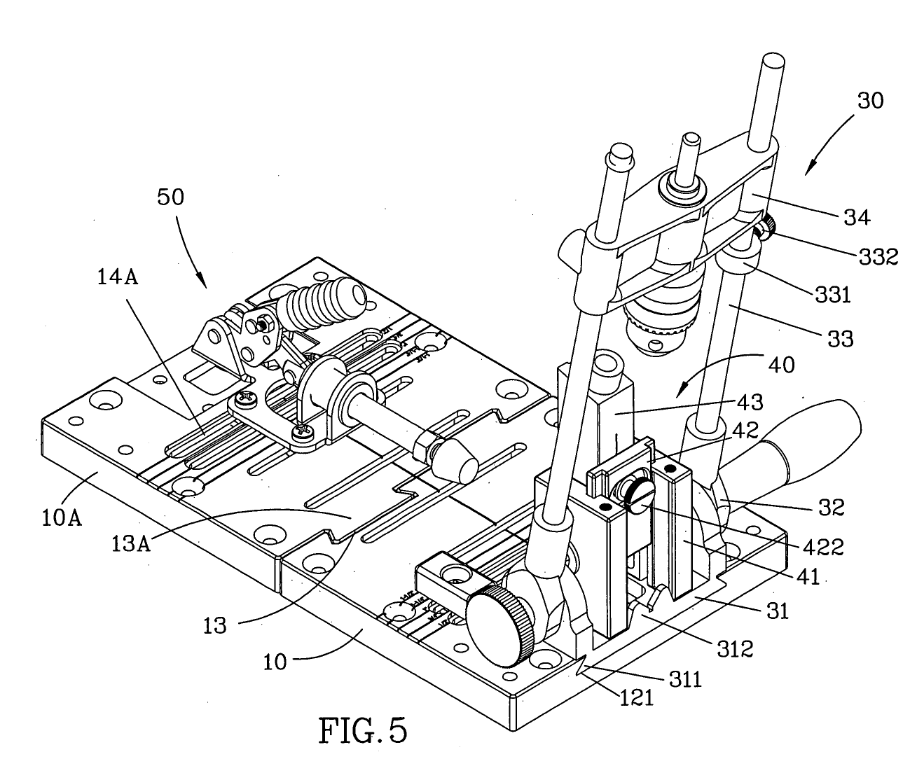

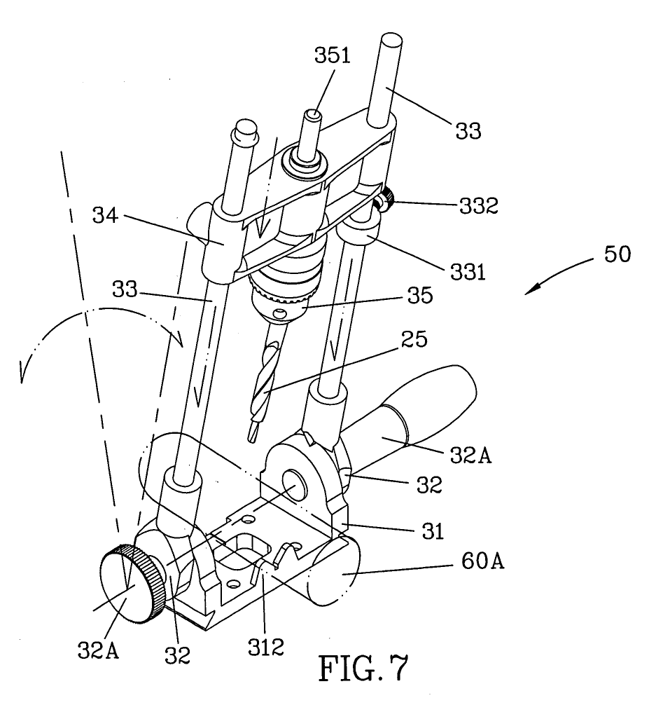

an angle adjustment module 30, as shown in FIGS. 1 and 5, comprises a base member 31 fittingly matches said recess 12 on the front of said flat worktable 10, the cross-sectional face of said base member 31 being shaped like [symbol] , the bilateral sides of said base member being angularly indented into dovetail-shaped portions 311, and said dovetail-shaped portions match and fit into said dovetail-shaped troughs 121 of frontal recess 12 in said flat worktable 10 for horizontally docking and securing the flat worktables, a rectangular opening 313 being disposed at the center of said base member 31 and four alignment openings 314 being formed at four corners of said base member; V-shaped supporting portions 312 being disposed at the front and rear edges of said base member 31 for supporting and aligning a workpiece, and as indicated by the imaginary lines in FIG. 7, said V-shaped supporting portions being supportive of a workpiece like cylindrical wooden stick 60A, and secured the workpiece in the sunken portion of “V” for drilling to take place at the center of said cylindrical wooden stick without deviation; said base member 31 also includes two pivotal bases 32 correspondingly disposed at the left and the right edges for adjusting and aligning angles as well as a fastening screw 32A for securing said pivotal base 32, and rods 33 of predetermined length being vertically fitted at the top of said pivotal bases 32, a sliding slot 34 being fitted through two said rods 33, a fastener 35 being fitted through the central axis of said sliding slot 34 for securing drill bit, said fastener also has a driveshaft 351 at the top for linking to external driving force; the part of said rod 33 beneath said sliding slot 34 being fitted with a fastening loop 331, said fastening loop 331 being penetrated and secured by fastening screws 332 for serving as a limit to the extent of sliding to said sliding slot 34;

a height adjustment module 40 comprised of two parallel support members 41 vertically fitted into the recess at the front edge of said flat worktable, said two parallel support members 41 have corresponding longitudinal sliding troughs 411 on opposing surfaces, respectively, a height adjustment piece 42 being embedded between and movable along said two longitudinal sliding troughs 411, a transverse sliding trough 421 being through said height adjustment piece 42, and a guide member 43 with guide openings 431 disposed through said height adjustment piece, said guide member 43 and said height adjustment piece 42 being secured together with the use of a fastening screw 422 on the rear side of said guide member 43, once said height adjustment piece 42 has been adjusted to adequate height, drilling operations can be guided successfully; a through trough 412 is symmetrically formed in parallel relation to said longitude sliding trough 411 in each of said parallel support members 41, a through opening 432 being horizontally disposed in the inner side of said guide member 43, and a horizontal rod 44 being secured through said through trough 412 with the use of a bolt 441 and a nut 442 at the two ends of said horizontal rod; two pivotal openings 413 being longitudinally formed through said two parallel support members 41 for securing said base member 31 with the use of fastening screws 21 1A into said alignment openings 314;

a clamp member 50 secured to parallel alignment grooves 14 of said flat worktable 10A, as indicated in FIGS. 2 and 4; the front end of said clamp member includes a fastener 51 for securing a workpiece 60;

the resulting device is for use in guiding the drilling operation on workpiece of all shapes and sizes.

Three types of embodiments and relevant figures are provided below as further explanation about the operation modes of multiple modules of this invention:

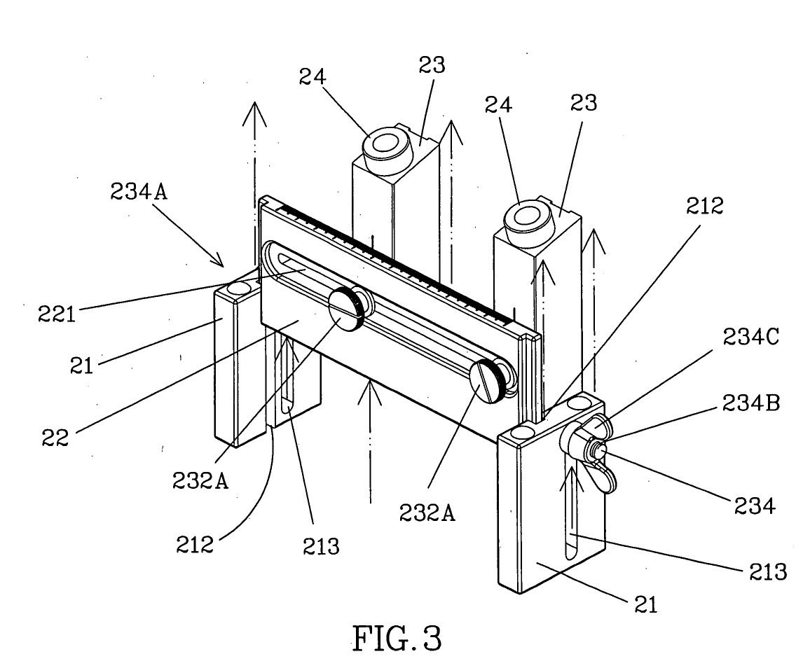

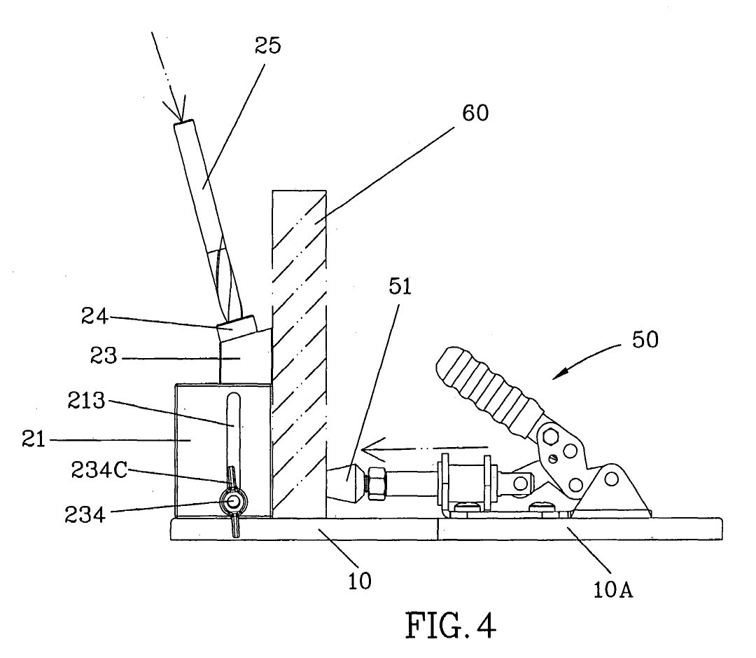

Firstly refer to FIG. 2, which is a three-dimensional integrated view showing the first operation mode of the invention; it is specifically designed for joining two wooden workpieces, and can be used for drilling evenly spaced holes in a fast and high-throughput manner, wherein the rear end of two flat worktables 10 and 10A has a set of dovetailing portions 13 and 13A that can dovetail into each other, thereby allowing the two flat worktables to dock together horizontally, the working area is substantially increased after the docking. Moreover, as indicated in FIGS. 3 and 4; in the longitude-transverse adjustment module 20 that is vertically arranged at the front edge of the flat worktable 10, when workpiece 60 is forced against guide member 23 from the pushing of tightening portion 51 at the front of clamp member 50, the user can then activate an electric hand drill (not shown in the figure), and drill bit 25 subsequently goes through guide sleeve 24 and drills an angular hole on workpiece 60. Because drill bit 25 stays within guide sleeve 24 during drilling, guide sleeve 24 can enhance the stability of the drill bit in a resulted hole, which in turn elevates the precision of drilling, and guide sleeve 24 can also prevent drill bit 25 from damaging guide member 23 during drilling;

If one desires to adjust the longitudinal-vertical height of guide member 23 in relation to flat worktable 10, clamp member 50 is loosened first so that workpiece 60 is no longer pushed tightly against guide member 23; as shown in FIG. 3, and then nut 234C that is tightly screwed on horizontal rod 234 is also loosened, subsequently, horizontal rod 234 can be raised or lowered to adjust the longitudinal-vertical height of guide member 23 and adjustment piece 22 in relation to flat worktable 10, so that workpieces of all thicknesses and sizes and be secured and drilled, wherein adjustment piece 22 is embedded between and movable along the two longitudinal sliding troughs 212 that face each other in parallel to adjust the height. After fastening screw 232A on the inner side of said guide member 23 is loosened, the two guide members 23 that were originally secured through transverse sliding trough 221 can be move to the left or to the right for adjusting the space between the two, once the two guide members 23 are adjusted to the height required for the workpiece, one only needs to tighten fastening screw 232A and nut 234C again and then re-adjusts clamp member 50 before carrying out the following drilling operations.

Secondly refer to FIG. 5, which is a three-dimensional integrated view showing the second operation mode of the invention, it differs from the first operation mode in that the original longitude-transverse adjustment module 20 is removed, while angle adjustment module 30 and height adjustment module 40 are installed instead, wherein base member 31 of angle adjustment module 30 is secured into recess 12 of said flat worktable 10 because dovetail-shaped portions 311 at both lateral sides of base member 31 docks into dovetail-shaped troughs 121 of the frontal recess 12 of said flat worktable 10; as a result, adjustments can only be made by loosening fastening screws 32A located at both lateral sides of said base member 31. As shown in FIG. 7, the angle of rod 33 can be adjusted by pivotally adjusting pivotal base 32 and then secured by tightening the screws, and thus the position of sliding slot 34 that is fitted on the two rods 33 can be adjusted on a fixed angle, consequently a drill bit 25 being secured by a fastener 35 can accurately drill a hole at the center of a workpiece, such as a cylindrical wooden stick; that is supported on the V-shaped supporting portion 312, wherein the part of rod 33 beneath said sliding slot 34 is fitted with a fastening loop 331, once the fastening loop is penetrated and secured by fastening screws 332, it can act as a limit in the extent of sliding to said sliding slot 34, hence the depth of holes resulted from drilling can be precisely and safely controlled;

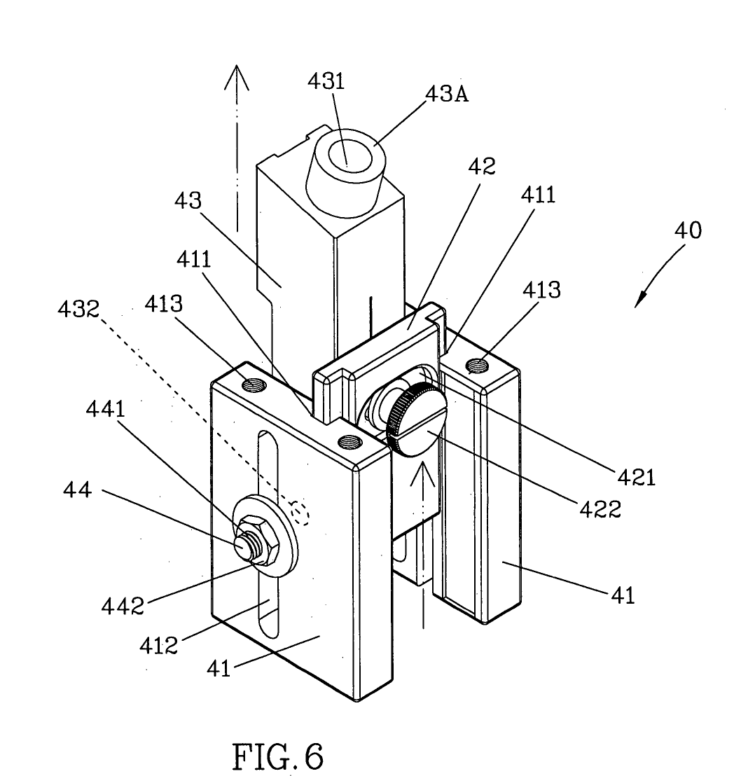

Subsequently, the height adjustment module 40 is vertically arranged and secured into the central rectangular opening 313 and the four alignment openings 314 at the four corners of base member 31. As a result, as indicated in FIG. 6, once fastening screws 422 and nuts 442 are loosened, height adjustment piece 42 that is disposed with guide member 43 can be moved along the longitudinal sliding troughs 411 at both sides and the height can be adjusted subsequently, said guide member 43 can also be moved horizontally along the horizontal sliding trough 421 in height adjustment piece 42 to make horizontal adjustments;

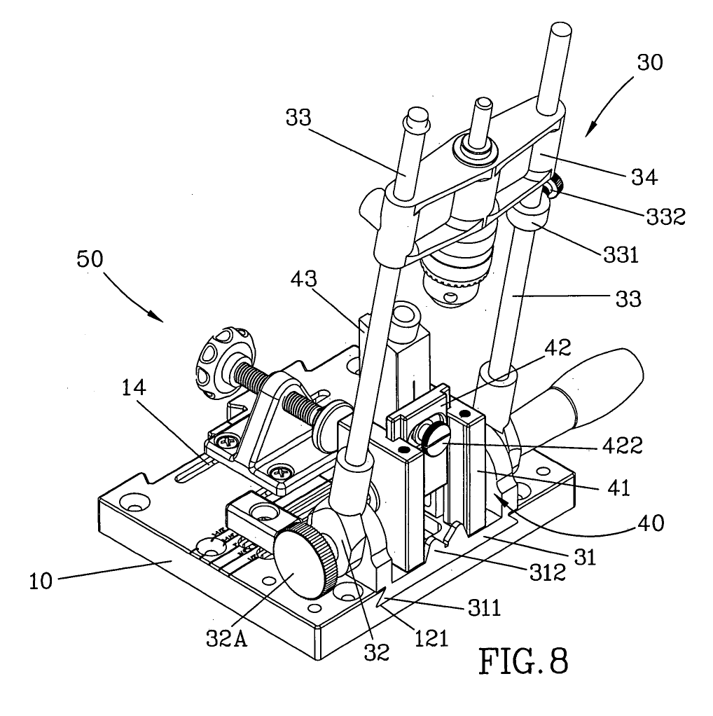

Finally, FIG. 8 is a three-dimensional integrated view showing the third operation mode of the invention, it differs from the previous operation modes in that the integrated form of two flat worktables 10 and 10A is taken apart, and only flat worktable 10 remains in order to reduce the overall working area. A screw with a shorter axis replaces the screw at the top of clamp member 50, so that shorter and smaller workpieces can be secured and operated on.

The embodiments described above only serve the purpose of explaining the invention and are not to be used to limit the scope of the invention in any ways; any changes in the values or any replacements of components of equal effects and functions are still viewed as within the scope of the invention.

We claim:

1. A holding fixture for use in all types of drilling concerning woodworking, comprising:
at least one flat worktable having a set of horizontal front alignment openings on the left and the right edges, and a horizontal front recess indented at the center, the rear end of said flat worktable also has a set of dovetailing portion for two said flat worktables to dovetail into each other horizontally;
a longitude-transverse adjustment module comprising two parallel support members vertically arranged on the left and right front edges of said flat worktable, the two parallel support members have a corresponding longitudinal sliding trough on the opposing surfaces, respectively, an adjustment piece being embedded between and movable along said two longitudinal sliding trough, a transverse sliding trough being through said adjustment piece, a guide member with a plurality of guide openings being horizontally movable in said transverse sliding trough for guiding drilling operations after said adjustment piece have been adjusted;
an angle adjustment module comprising a base member fittingly matches said recess on the front edge of flat worktable, V-shaped supporting portions being disposed at the front and rear edges of said base member for supporting and aligning a workpiece, pivotal bases being correspondingly disposed at the left and the right edges of said base member for adjusting and aligning angles, rods of predetermined length being vertically fitted at the top of said pivotal bases, a sliding slot being fitted through two said rods, a fastener being fitted through the central axis of said sliding slot for securing a drill bit, said fastener has a driveshaft at the top for linking to external driving force;
a height adjustment module comprising two parallel support members vertically fitted into the recess at the front edge of said flat worktable, the two parallel support members have corresponding longitudinal sliding troughs on the opposing surface, respectively, a height adjustment piece being embedded between and movable along said two longitudinal sliding troughs, a guide member with guide openings being disposed through said height adjustment piece for guiding drilling operations after said height adjustment piece have been adjusted;
a clamp member attached on the flat worktable, the front end of said clamp member includes a fastener for securing a workpiece;
the resulted device is for use in guiding the drilling operation on workpiece of all shapes and sizes.

2. The holding fixture for use in all types of drilling concerning woodworking of claim 1, wherein the top edge of the adjustment piece in said longitude-transverse adjustment module has a marked ruler, and the guide member has a marked notch along its middle longitudinal line, the combination of said marked notch and said marked ruler on the adjustment piece accurately measure the degree of horizontal movement of said guide member.

3. The holding fixture for use in all types of drilling concerning woodworking of claim 1, wherein the lateral edge located proximally to said longitudinal sliding trough of said parallel support member has a marked ruler for accurately measuring the degree of vertical movement of said guide member.

4. The holding fixture for use in all types of drilling concerning woodworking of claim 1, wherein the two parallel support members of said longitude-transverse adjustment module includes two longitudinally formed pivotal openings for securing said parallel support members at the alignment openings on said flat worktable with the use of fastening screws.

5. The holding fixture for use in all types of drilling concerning woodworking of claim 1, wherein the surface faces away from said longitudinal sliding trough in the two parallel support members being formed symmetrically indented through troughs, and the lateral side of said guide member being formed with a through opening, a horizontal rod being screwed into said through trough at both ends.

6. The holding fixture for use in all types of drilling concerning woodworking of claim 1, wherein said recess of the flat worktable has angularly indented symmetrical dovetail-shaped troughs on the left and the right lateral sides, respectively, the bilateral sides of the base member of said angle adjustment module being angularly indented into dovetail-shaped portions, and said dovetail-shaped portion matches said dovetail-shaped trough for horizontally docking and securing the flat worktables.

7. The holding fixture for use in all types of drilling concerning woodworking of claim 1, wherein the two parallel support members of said height adjustment module being formed with longitudinal pivotal openings through the members, and the location on the base member of said angle adjustment module corresponding to said pivotal openings being formed with two alignment openings for securing the two parallel support members with the use of fastening screws.

8. The holding fixture for use in all types of drilling concerning woodworking of claim 1, wherein the part of the rod beneath said sliding slot in said angle adjustment module being fitted with a fastening loop, said fastening loop being penetrated and secured by fastening screws for serving as a limit in the extent of sliding to said sliding slot.
